(19) United States
(12) Patent Application Publication
(10) Pub. No.: US 2026/0370793 A1
(43) Pub. Date: Nov. 19, 2026

(54) ELECTRONIC DEVICE, IMAGE CONVERTER, IMAGE DISPLAY METHOD AND ELECTRONIC DEVICE READABLE RECORDING MEDIUM

(71) Applicant: THERMALTAKE TECHNOLOGY CO., LTD., Taipei City (TW)

(72) Inventors: PEI-HSI LIN, Taipei City (TW); JYH-WOEI CHEN, Taipei City (TW); HUNG-LIANG LIN, Taipei City (TW); CHU-AN HSIEH, Taipei City (TW); CHUN-KO LIU, Taipei City (TW); CHIEN-WEN PENG, Taipei City (TW)

(73) Assignee: THERMALTAKE TECHNOLOGY CO., LTD., Taipei City (TW)

(21) Appl. No.: 19/281,777

(22) Filed: Jul. 28, 2025

(30) Foreign Application Priority Data
May 15, 2025 (TW) 114118330

(51) Int. Cl. H04N 13/302; G06F 1/20; G06T 7/11; H04N 13/139

(52) U.S. Cl. CPC H04N 13/302; G06F 1/20; G06T 7/11; H04N 13/139

(57) ABSTRACT

The present disclosure provides an electronic device, including a plurality of screens and a converter, where the plurality of screens are arranged according to a spatial relationship and the converter is coupled to the plurality of screens and used to receive an input image and a selection instruction, the input image is a panoramic image, and the selection instruction is used to frame a selection area in the input image. The converter executes an image segmentation algorithm and converts the input image into a plurality of output images according to the spatial relationship, and the output images respectively correspond to the plurality of screens, so that when the output images are synchronously displayed on the corresponding screens, the output images mutually form parallax and overlap to form a three-dimensional image. Thus, the electronic device of the present disclosure can provide a purpose with autostereoscopic 3D displays effects.

### CROSS-REFERENCE TO RELATED APPLICATION

This non-provisional application claims priority under 35 U.S.C. § 119(a) on Patent Application No(s). 114118330 filed in Taiwan, R.O.C. on May. 15, 2025, the entire contents of which are hereby incorporated by reference.

### BACKGROUND OF THE INVENTION

### Field of the Invention

The present disclosure relates to an electronic device, an image converter, an image display method and an electronic device readable recording medium, and in particular to an electronic device, an image converter, an image display method and an electronic device readable recording medium that can provide autostereoscopic 3D displays effects.

### Description of the Related Art

With the rapid development of science and technology and the rise of e-sports industry, the requirements for performance of e-sports computers also become higher, and the improvement of performance of computers is accompanied by an increase in the heat generated by components inside the computers, which has a serious impact on the use efficiency and service life of the computers. Therefore, it is necessary to provide a good cooling device to cool computer components to ensure smooth operation of the computers.

### BRIEF SUMMARY OF THE INVENTION

However, a display device installed on the conventional cooling device, such as a water block, relies only on the presentation of numbers or text to display information about the computer, which is boring and makes the user lack interest or neglect to watch the display device.

The applicant has made great efforts to research and develop an electronic device, an image converter, an image display method and an electronic device readable recording medium that can provide autostereoscopic 3D displays effects so as to make the spectator more interested in the cooling device.

In view of this, the present disclosure provides an electronic device, including: a plurality of screens, arranged according to a spatial relationship; and a converter, coupled to the plurality of screens and used to receive an input image and a selection instruction. The input image is a panoramic image. The selection instruction is used to frame a selection area in the input image. The converter executes an image segmentation algorithm and converts the input image into a plurality of output images respectively corresponding to the plurality of screens according to the spatial relationship, so that when the output images are synchronously displayed on the corresponding screens, the output images mutually form parallax and overlap to form a three-dimensional image. The image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

In an embodiment, a number of the screens is two, and the spatial relationship is that the two screens are perpendicular to each other.

In an embodiment, a number of the screens is three/four, and the spatial relationship is that every two of the three screens/the four screens are perpendicular to each other.

In an embodiment, the converter receives a flip instruction to adjust a viewing direction of the input image facing the selection area.

In an embodiment, the electronic device of the present disclosure further includes a cooling module. Surfaces of the cooling module are provided with the screens.

In an embodiment, the cooling module is a water block.

In an embodiment, the electronic device of the present disclosure further includes a storage device electrically connected to the converter. The storage device is used to store the output images.

In an embodiment, the storage device is arranged on a user terminal or directly on the electronic device.

The present disclosure further provides an image converter, suitable to be coupled to a plurality of screens. The image converter includes: a storage device, storing a plurality of scripts; and a processor, electrically connected to the storage device. After executing the scripts, the processor performs the following steps: receiving an input image and a selection instruction, the input image being a panoramic image, and the selection instruction being used to frame a selection area in the input image; and executing an image segmentation algorithm to convert the input image into a plurality of output images respectively corresponding to the plurality of screens according to a spatial relationship, so that when the output images are synchronously displayed on the corresponding screens, the output images mutually form parallax and overlap to form a three-dimensional image. The image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

In an embodiment, the storage device is a non-volatile memory.

The present disclosure further provides an image display method, including: assembling a plurality of screens according to a spatial relationship; receiving an input image and a selection instruction by a converter, the input image being a panoramic image, and the selection instruction being used to frame a selection area in the input image; and executing, by the converter, an image segmentation algorithm, and converting the input image into a plurality of output images respectively corresponding to the plurality of screens according to the spatial relationship, so that when the output images are synchronously displayed on the corresponding screens, the output images mutually form parallax and overlap to form a three-dimensional image. The image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

In an embodiment, a number of the screens is two, and the spatial relationship is that the two screens are perpendicular to each other.

In an embodiment, a number of the screens is three/four, and the spatial relationship is that every two of the three screens/the four screens are perpendicular to each other.

In an embodiment, the converter receives a flip instruction to adjust a viewing direction of the input image facing the selection area.

In an embodiment, the image display method of the present disclosure further includes storing the output images by a storage device such that the converter receives the output images from the storage device.

The present disclosure further provides an electronic device readable recording medium, storing a plurality of program codes such that an electronic device, when executing the plurality of program codes, performs the following steps: receiving an input image and a selection instruction, the input image being a panoramic image, and the selection instruction being used to frame a selection area in the input image; and executing an image segmentation algorithm to convert the input image into a plurality of output images respectively corresponding to a plurality of screens according to a spatial relationship, so that when the output images are synchronously displayed on the corresponding screens, the output images mutually form parallax and overlap to form a three-dimensional image. The image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

The present disclosure further provides an electronic device, including: a cooling module; a plurality of screens, arranged on the cooling module according to a spatial relationship, the screens being respectively used to display an output image; and a processing module, electrically connected to the screens and used to control the screens to synchronously display the respective output images such that the output images mutually form parallax and overlap to form a three-dimensional image.

In an embodiment, the cooling module is a water block.

In an embodiment, a number of the screens is two, and the spatial relationship is that the two screens are perpendicular to each other.

In an embodiment, a number of the screens is three/four, and the spatial relationship is that every two of the three screens/the four screens are perpendicular to each other.

In an embodiment, the electronic device of the present disclosure further includes a storage device electrically connected to the processing module. The storage device is used to store the output images.

In an embodiment, the storage device is arranged on a user terminal or directly on the electronic device.

Based on the above, the electronic device, the image converter, the image display method and the electronic device readable recording medium of the present disclosure can provide autostereoscopic 3D displays effects, so that no matter the spectator views from the direction of any screen, the three-dimensional image converted from the image can provide autostereoscopic 3D displays effects, thus improving the visual effect of the screens.

### BRIEF DESCRIPTION OF THE DRAWINGS

FIG. 1 is a block diagram of a first embodiment of an electronic device of the present disclosure.

FIGS. 2A,2B,2C and 2D, are views of the first embodiment of the electronic device of the present disclosure in use.

FIG. 3 is a three-dimensional view of a second embodiment of an electronic device of the present disclosure.

FIG. 4 is a block diagram of a third embodiment of an electronic device of the present disclosure.

FIG. 5 is a block diagram of an image converter of the present disclosure.

FIG. 6 is a flowchart of steps of the image converter of the present disclosure.

FIG. 7 is a flowchart of steps of a first embodiment of an image display method of the present disclosure.

FIG. 8 is a flowchart of steps of a second embodiment of an image display method of the present disclosure.

### DETAILED DESCRIPTION OF THE INVENTION

The present disclosure will be further described in the following detailed description of exemplary embodiments with reference to the accompanying drawings. The same reference symbols in different drawings may denote the same or similar elements. In addition, the present disclosure may, however, be embodied in different forms and should not be construed as being limited to the embodiments described herein. Rather, these embodiments are provided so that the present disclosure will be thorough and complete, and will fully convey the scope of the present disclosure to those of ordinary skill in the art to which the present disclosure belongs. In the drawings, the shapes and sizes of the elements may be exaggerated for clarity, and the same reference symbols will be used throughout to indicate the same or similar components.

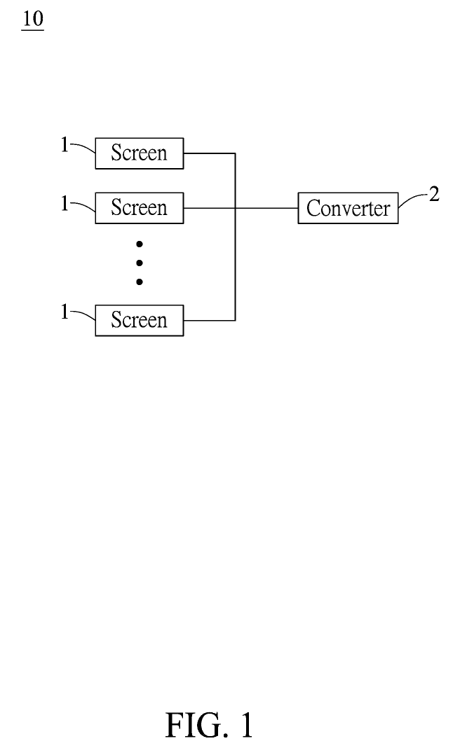

FIG. 1 is a block diagram of a first embodiment of an electronic device 10 of the present disclosure, which includes: a plurality of screens 1 and a converter 2. The converter 2 is coupled to the plurality of screens 1.

The screens 1 are arranged according to a spatial relationship. In this embodiment, when a number of the screens 1 is two, the spatial relationship is that the two screens 1 are perpendicular to each other, or when a number of the screens 1 is three/four, the spatial relationship is that every two of the three screens 1/the four screens 1 are perpendicular to each other.

The converter 2 is used to receive an input image and a selection instruction. The input image is a panoramic image. The selection instruction is used to frame a selection area in the input image. In this embodiment, the input image is a panoramic image, an image format of which may be, for example, MPEG-4. The converter 2 may be an application program installed in a user terminal. The user terminal may be a device such as a smart phone, a desktop computer, a notebook computer, a tablet computer or a server.

Preferably, the converter 2 may also receive a flip instruction to adjust a viewing direction of the input image facing the selection area.

The converter 2 executes an image segmentation algorithm, and converts the input image into a plurality of output images respectively corresponding to the plurality of screens 1 according to the spatial relationship, so that when the output images are synchronously displayed on the corresponding screens 1, the output images mutually form parallax and overlap to form a three-dimensional image.

In detail, the image segmentation algorithm cuts out a basic segment in the input image with the selection area, and takes the basic segment as the output image of one of the screens 1. The image segmentation algorithm then obtains an extension area corresponding to another screen based on the selection area and according to the spatial relationship, cuts out a corresponding extension segment in the input image with the extension area, and takes the extension segment as the output image of the another screen 1.

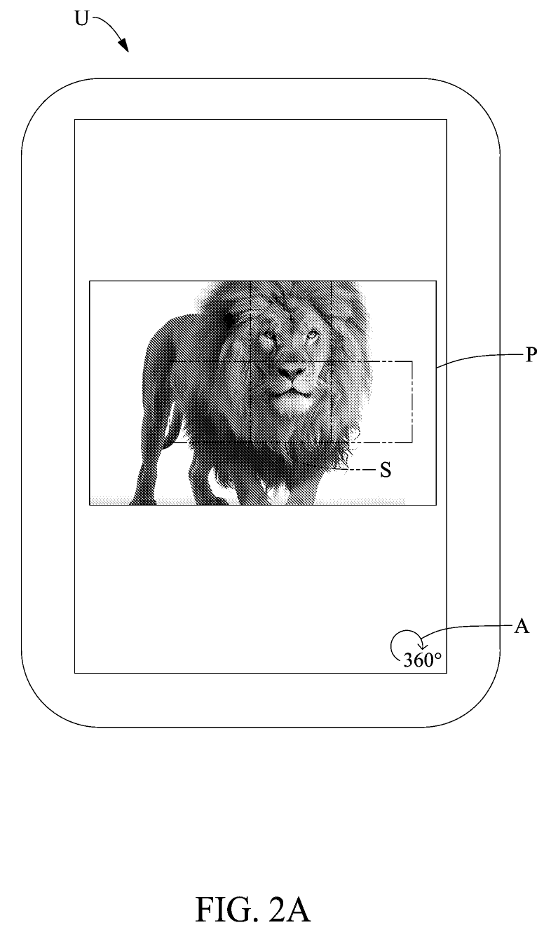

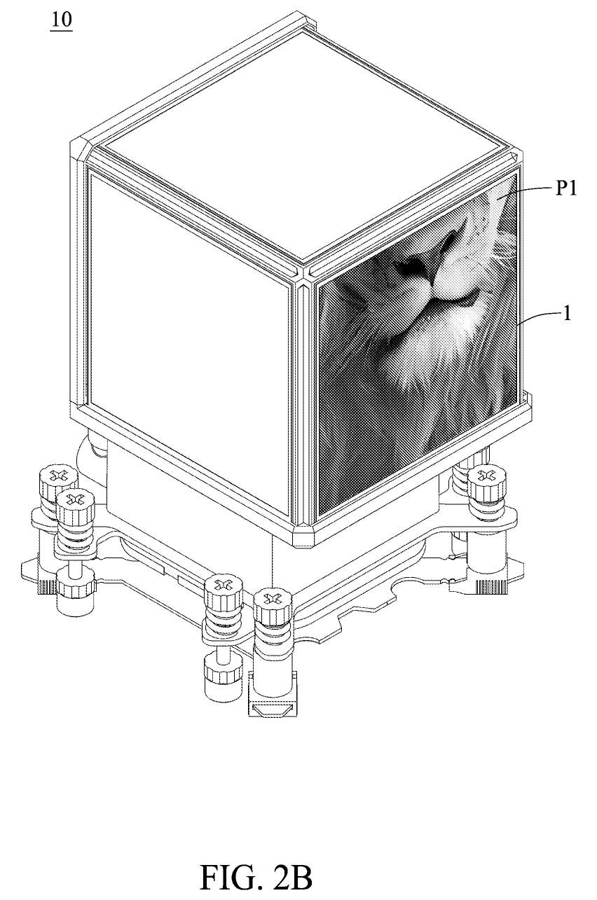

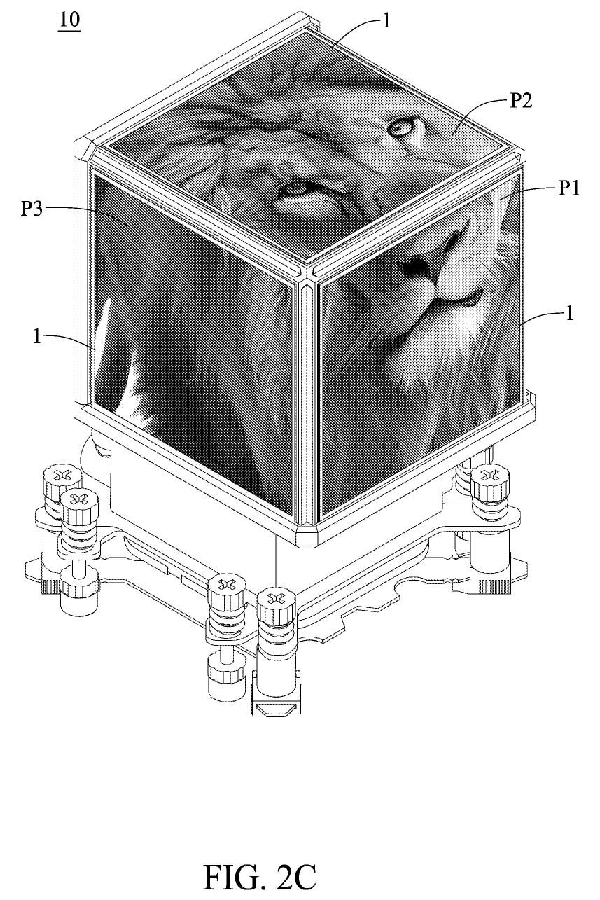

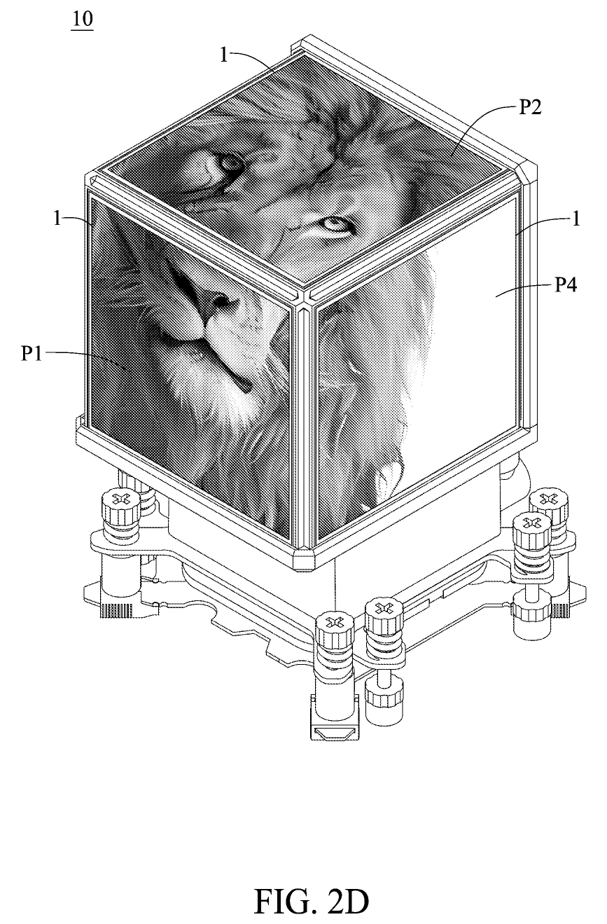

FIGS. 2A-2D are views of the electronic device 10 of the present disclosure in use. The user may input a panoramic image P into the electronic device 10 through a user terminal U, and view the panoramic image P at the user terminal U in a preview manner. The panoramic image P is, for example, but not limited to, an image of a lion. By operating the user terminal U, the user frames a selection area S in the panoramic image P as the output image P1 of one of the screens 1 (as shown in FIG. 2B). The user may also change the viewing direction of the panoramic image P facing the user by controlling a flip option A. The image segmentation algorithm then obtains an extension area corresponding to another screen 1 based on the selection area S and according to the spatial relationship, cuts out a corresponding extension segment in the panoramic image P with the extension area, and takes the extension segment as the output image P2, P3, P4 of the another screen 1 (as shown in FIGS. 2C and 2D ).

Thus, no matter the spectator views the output images from the direction of any of the screens 1, the three-dimensional image can provide autostereoscopic 3D displays effects.

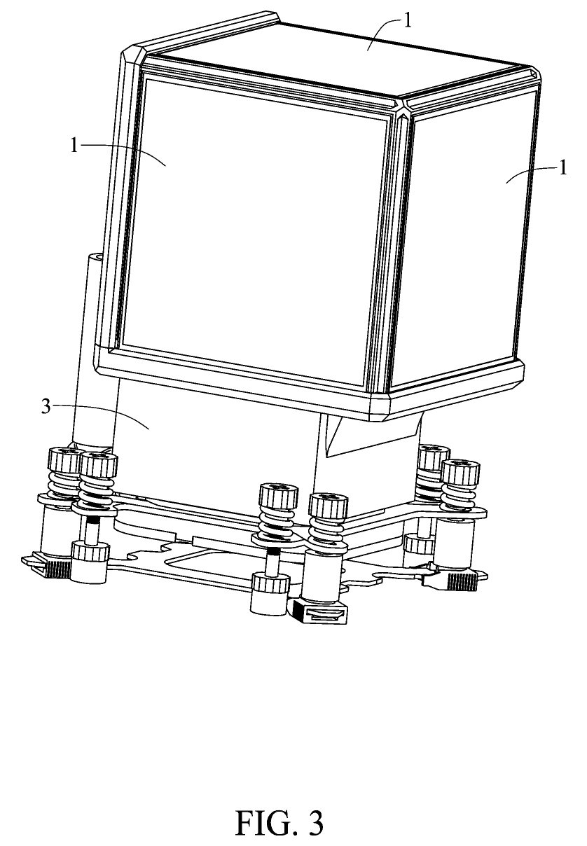

FIG. 3 is a three-dimensional view of a second embodiment of an electronic device 10 of the present disclosure, which, compared with the first embodiment, may further includes a cooling module 3, surfaces of which are provided with the screens 1. In this embodiment, the cooling module 3 may be a water block. In other embodiments, the cooling module 3 may further be a digital photo frame or an electronic advertising billboard.

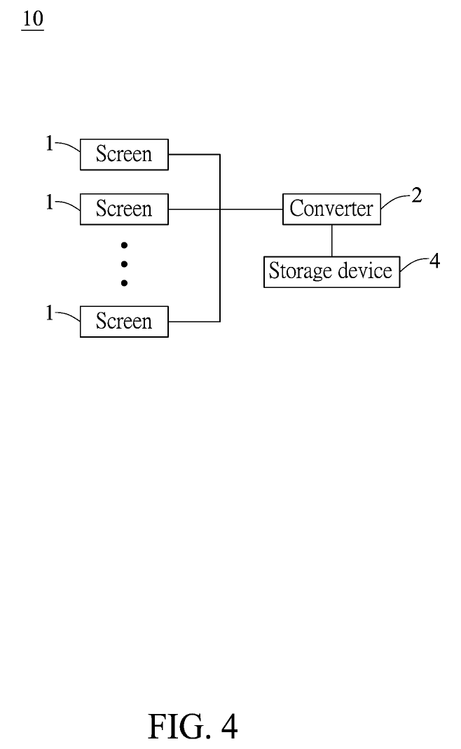

FIG. 4 is a block diagram of a third embodiment of an electronic device 10 of the present disclosure, which, compared with the first embodiment and the second embodiment, may further include a storage device 4 electrically connected to the converter 2 and used to store the output images. In this embodiment, the storage device 4 may be a memory or a hard disk, such as a non-volatile memory (ROM) or another type of memory. The storage device 4 may be arranged on the user terminal or directly on the electronic device 10. This can prevent the converter 2 from being unable to read the output images after the electronic device 10 is powered off and the power source is restored, making the screens 1 unable to display the output images.

In other embodiments, the present disclosure may further provide an electronic device 10, including a cooling module 3 described above, a plurality of screens 1 described above and a processing module. The cooling module 3 may be a water block. The screens 1 are arranged on the cooling module 3 according to a spatial relationship (as shown in FIG. 3), and the screens are respectively used to display an output image. The processing module is electrically connected to the screens 1 and used to control the screens 1 to synchronously display the respective output images such that the output images mutually form parallax and overlap to form a three-dimensional image. In this embodiment, the processing module may be a microcontroller.

In this embodiment, when a number of the screens 1 is two, the spatial relationship is that the two screens 1 are perpendicular to each other, or when a number of the screens 1 is three/four, the spatial relationship is that every two of the three screens 1/the four screens 1 are perpendicular to each other. Preferably, the electronic device may further include a storage device 4 described above, electrically connected to the processing module and used to store the output images. In this embodiment, the storage device 4 may be a memory or a hard disk, such as a non-volatile memory (ROM) or another type of memory. The storage device 4 may be arranged on the user terminal or directly on the electronic device 10.

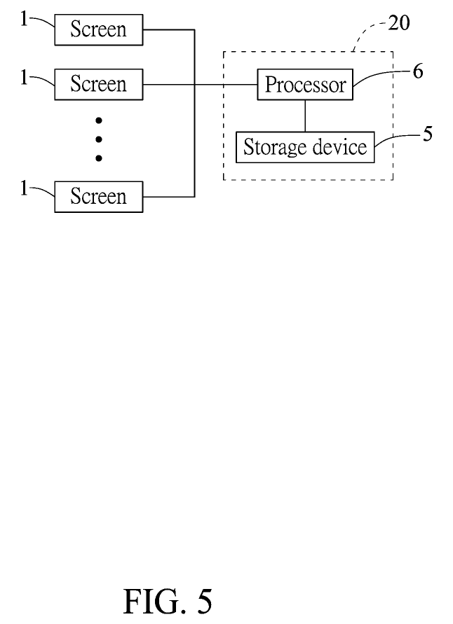

FIG. 5 is a block diagram of a first embodiment of an image converter 20 of the present disclosure, which is suitable to be coupled to a plurality of screens 1 described above. The image converter includes: a storage device 5 and a processor 6. The storage device 5 stores a plurality of scripts. The processor 6 is electrically connected to the storage device 5, and after executing the scripts, performs the following steps:

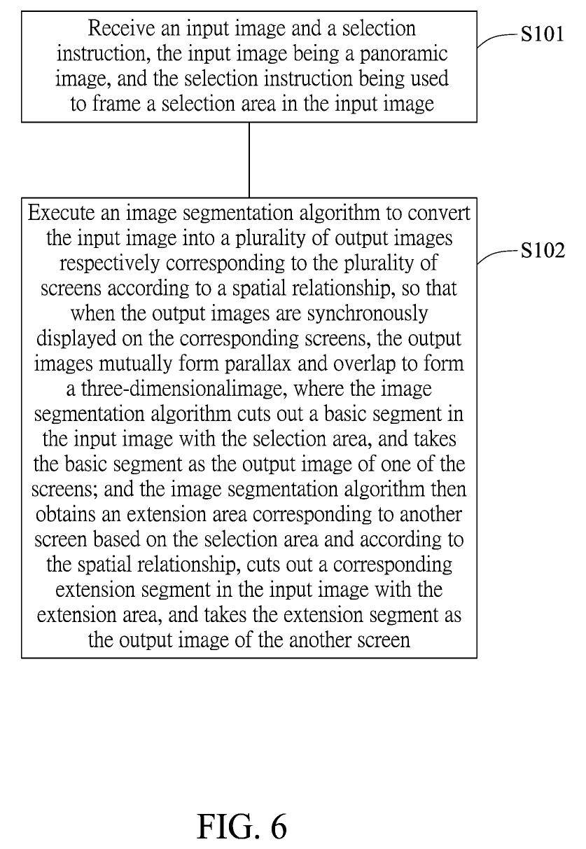

Referring to FIG. 6, in step S101, an input image and a selection instruction are received. The input image is a panoramic image, and the selection instruction is used to frame a selection area in the input image. In this embodiment, the input image is a panoramic image, an image format of which may be, for example, MPEG-4.

Referring to FIG. 6, in step S102, an image segmentation algorithm is executed to convert the input image into a plurality of output images respectively corresponding the plurality of screens 1 according to a spatial relationship, so that when the output images are synchronously displayed on the corresponding screens 1, the output images mutually form parallax and overlap to form a three-dimensional image. The image segmentation algorithm cuts out a basic segment in the input image with the selection area, and takes the basic segment as the output image of one of the screens 1. The image segmentation algorithm then obtains an extension area corresponding to another screen based on the selection area and according to the spatial relationship, cuts out a corresponding extension segment in the input image with the extension area, and takes the extension segment as the output image of the another screen 1.

In this embodiment, the storage device 5 may be a memory or a hard disk, such as a non-volatile memory (ROM) or another type of memory, and the processor 6 may be a microcontroller unit.

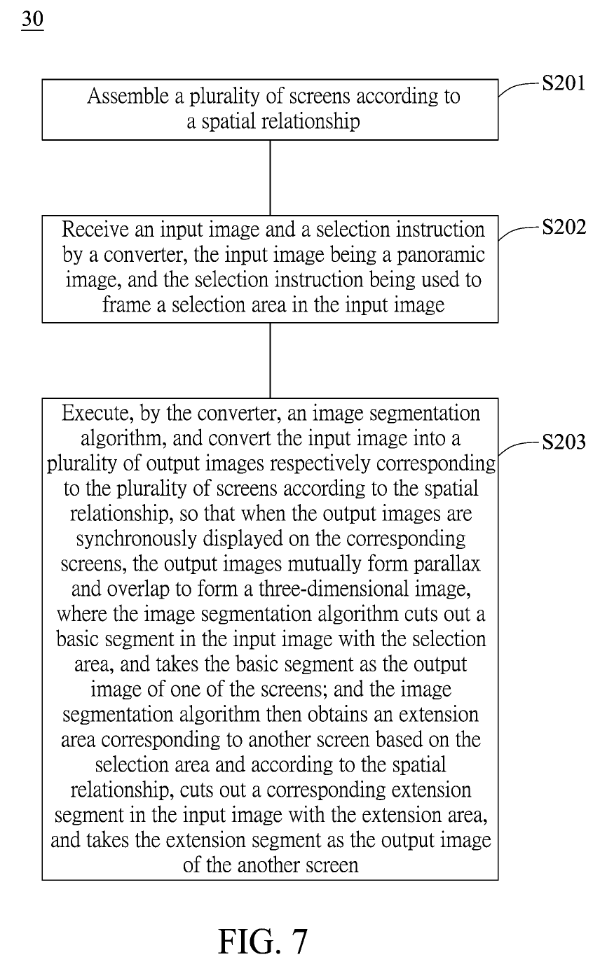

FIG. 7 is a flowchart of steps of a first embodiment of an image display method 30 of the present disclosure, which includes the following steps:

In step S201, a plurality of screens 1 described above are assembled according to a spatial relationship.

In step S202, a converter 2 described above receives an input image and a selection instruction. The input image is a panoramic image, and the selection instruction is used to frame a selection area in the input image. In this embodiment, the input image is a panoramic image, an image format of which may be, for example, MPEG-4.

Preferably, the converter 2 may also receive a flip instruction to adjust a viewing direction of the input image facing the selection area.

In step S203, the converter 2 executes an image segmentation algorithm, and converts the input image into a plurality of output images respectively corresponding to the plurality of screens 1 according to the spatial relationship, so that when the output images are synchronously displayed on the corresponding screens 1, the output images mutually form parallax and overlap to form a three-dimensional image.

In detail, the image segmentation algorithm cuts out a basic segment in the input image with the selection area, and takes the basic segment as the output image of one of the screens 1. The image segmentation algorithm then obtains an extension area corresponding to another screen based on the selection area and according to the spatial relationship, cuts out a corresponding extension segment in the input image with the extension area, and takes the extension segment as the output image of the another screen 1.

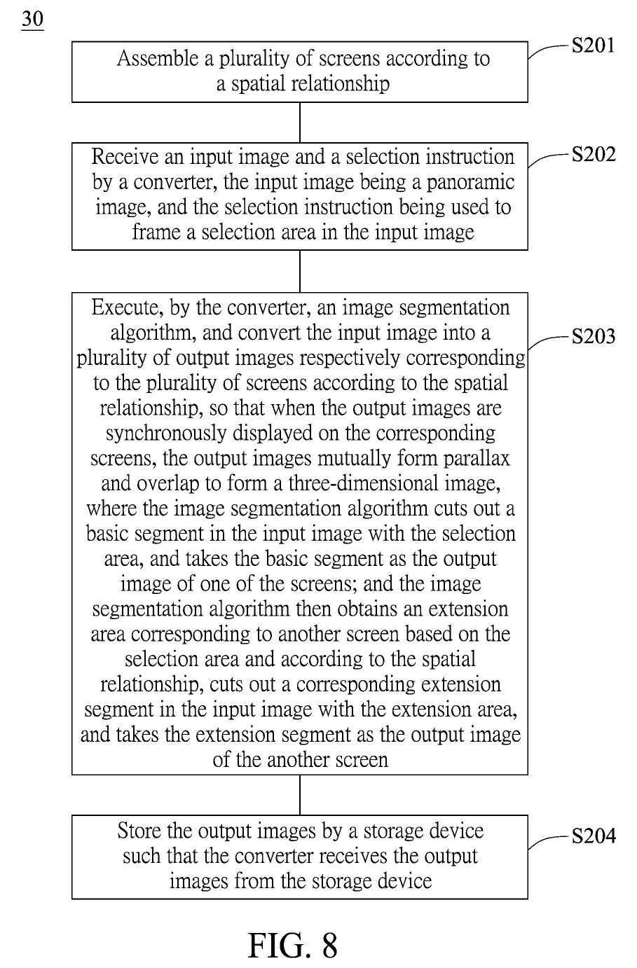

FIG. 8 is a flowchart of steps of a second embodiment of an image display method 30 of the present disclosure, which, compared with the first embodiment, may further include the following step:

In step S204, a storage device 4 described above stores the output images such that the converter 2 receives the output images from the storage device 4.

The present disclosure further provides an electronic device readable recording medium, storing a plurality of program codes such that an electronic device, when executing the plurality of program codes, performs the following steps: receiving an input image and a selection instruction, the input image being a panoramic image, and the selection instruction being used to frame a selection area in the input image; and executing an image segmentation algorithm to convert the input image into a plurality of output images respectively corresponding to a plurality of screens 1 described above according to a spatial relationship, so that when the output images are synchronously displayed on the corresponding screens 1, the output images mutually form parallax and overlap to form a three-dimensional image. The image segmentation algorithm cuts out a basic segment in the input image with the selection area, and takes the basic segment as the output image of one of the screens 1. The image segmentation algorithm then obtains an extension area corresponding to another screen based on the selection area and according to the spatial relationship, cuts out a corresponding extension segment in the input image with the extension area, and takes the extension segment as the output image of the another screen 1. The electronic device may be a device such as a smart phone, a desktop computer, a notebook computer, a tablet computer or a server.

Based on the above, the electronic device, the image converter, the image display method and the electronic device readable recording medium of the present disclosure can provide autostereoscopic 3D displays effects, so that no matter the spectator views from the direction of any screen, the three-dimensional image converted from the image can provide autostereoscopic 3D displays effects, thus improving the visual effect of the screens.

Although the present disclosure has been described by means of specific embodiments, many modifications and changes can be accomplished by those of ordinary skill in the art to which the present disclosure belongs without departing from the scope and spirit of the present disclosure as set forth in the appended claims. Therefore, the protection of this application should be as defined in the claims, not as disclosed in the specification.

What is claimed is:

1. An electronic device, comprising:
a plurality of screens, arranged according to a spatial relationship; and
a converter, coupled to the plurality of screens and used to receive an input image and a selection instruction, the input image being a panoramic image, the selection instruction being used to frame a selection area in the input image, the converter executing an image segmentation algorithm and converting the input image into a plurality of output images respectively corresponding to the plurality of screens according to the spatial relationship, so that when the output images are synchronously displayed on the corresponding screens, the output images mutually form parallax and overlap to form a three-dimensional image,
wherein the image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

2. The electronic device according to claim 1, wherein a number of the screens is two, and the spatial relationship is that the two screens are perpendicular to each other.

3. The electronic device according to claim 1, wherein a number of the screens is three/four, and the spatial relationship is that every two of the three screens/the four screens are perpendicular to each other.

4. The electronic device according to claim 1, wherein the converter receives a flip instruction to adjust a viewing direction of the input image facing the selection area.

5. The electronic device according to claim 1, further comprising a cooling module, surfaces of the cooling module being provided with the screens.

6. The electronic device according to claim 5, wherein the cooling module is a water block.

7. The electronic device according to claim 1, further comprising a storage device electrically connected to the converter, the storage device being used to store the output images.

8. The electronic device according to claim 7, wherein the storage device is arranged on a user terminal or directly on the electronic device.

9. An image converter, suitable to be coupled to a plurality of screens, the image converter comprising:
a storage device, storing a plurality of scripts; and
a processor, electrically connected to the storage device, after executing the scripts, the processor performing the following steps:
receiving an input image and a selection instruction, the input image being a panoramic image, and the selection instruction being used to frame a selection area in the input image; and
executing an image segmentation algorithm to convert the input image into a plurality of output images respectively corresponding to the plurality of screens according to a spatial relationship, so that when the output images are synchronously displayed on the corresponding screens, the output images mutually form parallax and overlap to form a three-dimensional image,
wherein the image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

10. The image converter according to claim 9, wherein the storage device is a non-volatile memory.

11. An image display method, comprising:
assembling a plurality of screens according to a spatial relationship;
receiving an input image and a selection instruction by a converter, the input image being a panoramic image, and the selection instruction being used to frame a selection area in the input image; and
executing, by the converter, an image segmentation algorithm, and converting the input image into a plurality of output images respectively corresponding to the plurality of screens according to the spatial relationship, so that when the output images are synchronously displayed on the corresponding screens, the output images mutually form parallax and overlap to form a three-dimensional image,
wherein the image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

12. The image display method according to claim 11, wherein a number of the screens is two, and the spatial relationship is that the two screens are perpendicular to each other.

13. The image display method according to claim 11, wherein a number of the screens is three/four, and the spatial relationship is that every two of the three screens/the four screens are perpendicular to each other.

14. The image display method according to claim 11, wherein the converter receives a flip instruction to adjust a viewing direction of the input image facing the selection area.

15. The image display method according to claim 11, further comprising storing the output images by a storage device such that the converter receives the output images from the storage device.

16. An electronic device readable recording medium, storing a plurality of program codes such that an electronic device, when executing the plurality of program codes, performs the following steps: receiving an input image and a selection instruction, the input image being a panoramic image, and the selection instruction being used to frame a selection area in the input image; and executing an image segmentation algorithm to convert the input image into a plurality of output images respectively corresponding to a plurality of screens according to a spatial relationship, so that when the output images are synchronously displayed on the corresponding screens, the output images mutually form parallax and overlap to form a three-dimensional image, wherein the image segmentation algorithm cuts out a basic segment in the input image with the selection area, takes the basic segment as the output image of one of the screens, obtains an extension area corresponding to another screen based on the selection area and according to the spatial relationship, cuts out a corresponding extension segment in the input image with the extension area, and takes the extension segment as the output image of the another screen.

17. An electronic device, comprising:
a cooling module;
a plurality of screens, arranged on the cooling module according to a spatial relationship, the screens being respectively used to display an output image; and
a processing module, electrically connected to the screens and used to control the screens to synchronously display the respective output images such that the output images mutually form parallax and overlap to form a three-dimensional image.

18. The electronic device according to claim 17, wherein the cooling module is a water block.

19. The electronic device according to claim 17, wherein a number of the screens is two, and the spatial relationship is that the two screens are perpendicular to each other.

20. The electronic device according to claim 17, wherein a number of the screens is three/four, and the spatial relationship is that every two of the three screens/the four screens are perpendicular to each other.

21. The electronic device according to claim 17, further comprising a storage device electrically connected to the processing module, the storage device being used to store the output images.

22. The electronic device according to claim 21, wherein the storage device is arranged on a user terminal or directly on the electronic device.
